(19) United States
(12) Patent Application Publication
(10) Pub. No.: US 2010/0047654 A1
(43) Pub. Date: Feb. 25, 2010

(54) FUEL CELL SYSTEM

(75) Inventors: Kazuhiro YASUDA, Kanagawa (JP); Hideyuki Ohzu, Kanagawa (JP); Yoshihiko Nakano, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Kabushiki Kaisha Toshiba, Tokyo (JP)

(21) Appl. No.: 12/609,658

(22) Filed: Oct. 30, 2009

Related U.S. Application Data
(62) Division of application No. 11/227,328, filed on Sep. 16, 2005.

(30) Foreign Application Priority Data
Sep. 21, 2004 (JP) 2004-273512
Mar. 30, 2005 (JP) 2005-099287

(51) Int. Cl. H01M 8/10; C01G 25/00

(52) U.S. Cl. 429/30; 252/184

(57) ABSTRACT

The fuel cell system of liquid fuel direct supply type includes an proton-conductive solid polymer film as an electrolyte, a cell part containing an anode and a cathode disposed to face each other with the proton-conductive solid polymer film intervening therebetween, a filter for removing metallic ions from a liquid fuel, a fuel supplying line for supplying the liquid fuel to the cell part through the filter, and an oxygen supplying line for supplying oxygen to the cell part, and the filter contains an inorganic ion exchange material.

### CROSS REFERENCE TO RELATED APPLICATIONS

This application is based upon and claims the benefit of priority from the prior Japanese Patent applications No. 2004-273512, filed Sep. 21, 2004, and No. 2005-99287, 2005, filed March 30, the entire contents of which are incorporated herein by reference.

### BACKGROUND OF THE INVENTION

1. Field of the Invention

The present invention relates to a fuel cell system.

2. Description of the Related Art

A fuel cell used by circulating a liquid fuel is receiving attention as an electric power source for a mobile electronic device, such as small sized portable devices and personal computers, and has been earnestly studied and developed. In particular, a fuel cell system, in which high concentration methanol housed in a cartridge tank is continuously supplied and diluted in the system, has such an advantage that the fuel can be supplied easily at low cost.

However, in the fuel cell, in which a liquid fuel, such as methanol, is directly supplied to an electrode, the pH of the liquid fuel is lowered due to formic acid and carbon dioxide formed during the reaction on an anode, by which a slight amount of metallic ions are eluted from members used in the system (as disclosed in JP-A-2004-79210, hereafter 'JPA-210). Particularly in a fuel cell system, in which a high concentration fuel is diluted with water formed through electric power generation to attain prolonged driving time, the pH of the circulated liquid fuel is suddenly lowered to bring about such an adverse phenomenon in a short period of time. There are also some cases where metallic ions invade into the unit upon intake of air from the exterior of the system and upon exchange of the fuel cartridge. In addition, even with a fuel cartridge, there occur many cases where elongated contact of a fuel such as methanol and the like with the member inside the cartridge causes the cartridge-constituting material (mainly metal ion) to dissolve out into the fuel and where the contaminated fuel is supplied to the system to deteriorate the cell performance of the system.

The metallic ions originated from the inside and outside of the system are accumulated to cause deterioration of the cell capability in a short period of time. More specifically, upon lowering the pH of the liquid fuel in the unit, the constitutional members of the system are in contact with a liquid having a low pH, whereby a slight amount of metallic ions are eluted. The air introduced as an oxidizing agent from the exterior to the system also contains a slight amount of impurities, and metallic ions invade into the unit from the impurities. The metallic ions originated from the inside and outside of the unit are accumulated in a cell part, mainly an ion-conductive member, to lower the ion conductivity thereof, whereby the cell capability is deteriorated. In 'JPA-210, such a material as an absorbent, e.g., activated carbon, a photochemical catalyst and an ion exchange resin is used as a filter for adsorbing metallic ions. However, the filter cannot sufficiently suppress metallic ions from being eluted, and therefore, there is the problem of deterioration in cell capability still remaining.

In related art fuel cells, there has been a problem that metal ions originating from the interior part of the fuel cell unit, the fuel cartridge and the exterior environment accumulate in the ion-conductive member which is a significant part for the cell part, lead to the decrease of the ionic conductivity of the ion-conductive member, and thus resulting in a noticeable deterioration of the cell performance.

### BRIEF SUMMARY OF THE INVENTION

The present invention, which has been devised to solve the above-cited problem, has an object of providing a fuel cell system which is provided with a metal ion scavenger aiming to suppress the dissolution of metal ions and effectively reclaim the metal ions in concern and thus prevents the deterioration of the cell performance.

To solve the above-cited problem, the fuel cell system includes a proton-conductive solid polymer film as an electrolyte, a cell part including an anode and a cathode disposed to face each other with the proton-conductive solid polymer film intervening therebetween, a cation scavenger for removing metallic ions from a liquid fuel, a fuel supplying line for supplying the liquid fuel to the cell part while the liquid fuel is kept in contact with the ion scavenger, and an oxygen supplying line for supplying oxygen to the cell part, the ion scavenger containing an inorganic material provided with ion exchange capability.

### BRIEF DESCRIPTION OF THE DRAWINGS

FIG. 1 is a constitutional view of one embodiment of a direct methanol fuel cell according to the invention.

FIG. 2 is a constitutional view of another embodiment of a direct methanol fuel cell according to the invention.

FIG. 3 is a cross sectional view showing a piping, through which a liquid passes, of a DMFC unit of one embodiment according to the invention.

FIG. 4 is a cross sectional view of one embodiment of an ion exchange material according to the invention.

### DETAILED DESCRIPTION OF THE INVENTION

The invention will be described in detail below with reference to the embodiments according to the functions and purposes thereof.

By disposing an ion scavenger of the present invention within a cell unit or in a fuel cartridge of a fuel cell system in which a liquid fuel is supplied to an anode, the dissolution of metallic ions, which phenomenon acts to deteriorate cell performance, from the inside of the unit is suppressed, and at the same time, metallic ions entering the system from the external environment is efficiently reclaimed.

As is seen from the foregoing description, contamination of metallic ions, which is a cause of deteriorating the performance of a fuel cell system, occurs either by dissolution from the parts within the unit that contact with the fuel liquid, i.e., the piping which is connected to a cell component and through which the liquid fuel flows, and those used for cooling, or by invasion from outside due to external air introduction, due to the fuel supplied from a fuel cartridge and during cartridge replacement.

In the case where the metallic ions are mixed in the liquid fuel to be supplied to the anode, they are immediately incorporated into an ion-conductive part constituting the component of the cell part to lower considerably the proton conductivity, which causes deterioration in cell capability.

In the invention, in order to collect the metallic ions that are incorporated into the cell part from the inside and outside, a filter is provided or a fuel supplying line (piping) is modified. This is the most important constitution of the invention.

With respect to the elution from the internal piping and the like, a coated layer containing an ion exchange material is provided on the surface, at which the piping and the liquid are in contact with each other, to prevent the liquid and the piping from being in contact with each other, and metallic ions eluted from the piping are collected by an ion exchange material having been dispersed in the coated layer, whereby metallic ions are prevented from being eluted to the liquid inside the unit.

Metallic ions introduced into the liquid fuel upon intake of air and upon exchange of the cartridge are collected by passing through a filter immediately before supplying to the anode, whereby the metallic ions are prevented from being incorporated into the cell part.

With respect to the fuel cartridge, metallic ion ingredients, which dissolve out into the fuel from the cartridge vessel, are captured by the ion exchange material arranged inside the cartridge before the fuel is supplied to a DMFC unit.

As an ion exchange material, a polymer resin material has been ordinarily used (for example, stylene-vinyl benzene copolymer in Dowex 650C produced by Dow Chemical Company). However, the polymer ion exchange material has such problems that it has a small exchange capacity, cannot exert sufficient exchange capability unless it is in a hydrous state, and has a low exchange speed. In the invention, an inorganic ion exchange material is used, which has a relatively large exchange capacity and can exhibit ion exchange capability even in insufficient hydrous state. Specifically, examples of the inorganic ion exchange material includes zirconium phosphate and antimony oxide. Zirconium phosphate is preferably used in consideration of (1) the exchange capacity (about 6 times Nafion), (2) the exchange speed, and (3) the influence on the cell (elution of metallic ions constituting the ion exchange material).

In the invention, metallic ions invading from the inside and outside of the unit are collected by using the coated layer having the ion exchange material dispersed therein and the filter constituted by particles of ion exchange member. The coated layer provided for collecting metallic ions generated inside the unit or fuel cartridge is provided by coating a coated layer containing the ion exchange material on a part inside the unit, at which the liquid is in contact therewith, whereby metallic ions eluted from the interior of the unit (a member underlaying the coated layer) are collected by the ion exchange material dispersed in the coated layer to prevent them from being eluted into the liquid. The coated layer having the ion exchange material dispersed therein preferably contains an inorganic-organic composite material or an organic material having a hydrophilic property as a matrix member for forming the coated layer uniformly and firmly. In general, a polymer material or a metallic material coated with a resin is generally used as a part inside a fuel cell unit, at which a liquid is in contact therewith, particularly a piping. The ion exchange material used in the invention is mainly an inorganic material, and therefore, an inorganic-organic composite material or an organic material having a hydrophilic property is preferably used in consideration of the dispersibility of the inorganic ion exchange material and the affinity to the matrix member. An organic material may also be used as long as the chemical and mechanical stability is ensured. It is preferable that an organic material used for a composite material has a hydrophilic property in view of the dispersibility of the inorganic ion exchange material.

The ratio of the ion exchange material to the matrix member is preferably from 30 to 80% by weight, and more preferably from 40 to 70% by weight, based on the matrix member, for fixing the coated layer stably on the surface of the member and for maintaining the metallic ion collecting capability for a prolonged period of time.

Further, it is necessary that the coating layer, which must suppress the diffusion as ions of the metallic ingredient contained in the piping member into the liquid flowing through the piping, is composed so as to have a low water absorption property. Specifically, a water absorption ratio not exceeding 40%, desirably not exceeding 20% is preferred as the diffusion of metallic ions can be suppressed.

The thickness of the coated layer varies depending on the dispersed amount of the ion exchange material and is preferably about from 1 to 50 μm for maintaining the coated layer in favorable conditions for a prolonged period of time. Besides, the water absorption is preferably 10% or less for further suppressing the diffusion of metallic ions into the liquid.

In the case where the filter is used for collecting metallic ions having been eluted into the liquid, an inorganic-organic composite material, an inorganic material or a polymer material having the inorganic ion exchange material dispersed therein is molded into an aggregate of a spherical form and a form having a large specific surface area, whereby the pressure loss of the filter can be reduced, and metallic ions can be effectively collected.

Specifically, the filter mentioned here means aggregates obtained by dispersing an inorganic ion exchange material in an organic or inorganic material constituting a matrix member and thereafter processing the resulting dispersion into a particulate form. Since the particles constituting the filter exhibit the higher ion exchange capability for the higher porosity as well as the water absorption property thereof, it is preferred to carry out these treatments after the ion exchange material has been dispersed in the matrix member, or after the processing to particulate form. And, by taking into consideration the pressure loss of the liquid passing the filter and packing density, spherical particles are preferred with respect to the particle shape.

In that case, the particle size is preferably in the range of from 10 to 1000 μm, whereby, for the smaller particle size, the more increases the specific surface area as well as the packing density, thus leading to a higher ion-capturing capability. The specific surface area of the absorbing material used as a filter is preferably from 50 to 500 m²/g. The specific surface area lower than 50 m²/g causes the deterioration of ion-capturing capability, while the specific surface area larger than 500 m²/g causes a fear that liquid supply in the cell unit is lead to trouble since the inorganic ion exchange member dispersed therein is flew out in the liquid. However, if the particle size excessively reduces, pressure loss increases too much, and the damage caused by the liquid becomes serious. Accordingly, the particle size should preferably be in the above range.

In the case of a filter, since metallic ions in liquid must be captured in a short period of time, fabrication of one with a high water absorption is required. A specific value for water absorption is preferably 20% or more, more preferably 30% or more. Use of an organic composite material which is provided with, in addition to sufficient water absorption property, ion exchange capability is desirable since the stability (i.e., prevention of weight loss due to abrasion, etc.) of the inorganic material is enhanced by virtue of the improvement of dispersion property.

The source of metallic ions invading from the outside includes a cathode air intake part, an interior of the cartridge and a cartridge connecting part. Therefore, the filter of the invention is disposed in the vicinity of at least one of the metallic ion sources and immediately before the cell part. In such a fuel cell that a high concentration fuel housed in a cartridge is supplied and used after dilution inside the cell unit, it is preferred that the filter is disposed in interior of the high concentration fuel cartridge or in the vicinity of the cartridge in the unit, and the filter is exchanged at the same time when the cartridge is exchanged, whereby metallic ions can be continuously collected effectively.

The weight ratio of the ion exchange material to the matrix member in the filter is preferably from 1 to 80%, and more preferably from 25 to 65%, based on the matrix member, for remaining the shape of the filter for a long period of time and for ensuring the ion exchange material in an amount necessary for collecting metallic ions. In the case where the ratio is less than 1%, it is insufficient for collecting metallic ions, and in the case where it exceeds 80%, it is not preferred since the shape of the filter cannot be maintained for a long period of time, and powder of the ion exchange material flows out from the filter and accumulates in the piping in the unit or the interior of the cartridge to cause adverse effects.

It is preferred in the invention that a net is provided inside or outside the metallic ion filter part for preventing such a phenomenon that the member constituting the filter leaks into the interior of the unit to clog the flow path of the cell component and the like.

In case of using the above composite material comprising an inorganic ion exchange material and an organic matter, it is desirable to use a metal alcoxide as the organic matter that is usually used for the sol/gel method in order to control the dispersion property and the microscopic structure of the two materials, since films or granular particles with various closenesses and water absorption capabilities can be fabricated depending on the sol composition and the heat treatment after gel formation. Specifically, an organic matrix phase is formed with a metal alcoxide, a metal cetylacetonate or a metal carboxylate containing Si, Ti or Zr, and an inorganic ion exchange material such as zirconium phosphate is dispersed therein. The reason why Si, Ti and Zr are chosen here lies in the fact that, since these substances form finely divided hydroxide particles in solutions and cannot stably exist as ions, they do not adversely affect the deterioration of a cell component when used in fuel cells such as DMFC. In contrast thereto, when the metal alcoxide containing Al (for example, aluminum isopropoxide), which is one of the most widely used metal alcoxides, is used for the matrix phase, Al ion dissolves out during usage and accumulates in the electrolyte film as the cell component to undesirably deteriorate cell performance to a noticeable extent.

In case where the above coating layer is fabricated with a composite material of a metal alcoxide and an inorganic ion exchange member, a close film is formed by using sol that has low contents of water and of a desiccation-preventing agent (for example, formamide). On the other hand, when granular particles of high water absorbing property are to be formed as an ion filter, highly water absorbing particles can be prepared by forming sol with increased contents of water and of a desiccation-preventing agent followed by heat treatment at a temperature between 70 and 200° C. to separate the alcoxide component.

With respect to heating temperature in particular, heat treatment within a 100 to 200° C.-temperature range is preferred since organic ingredients can be eliminated. Heat treatment at an elevated temperature exceeding 250° C. is not preferred because water in the inorganic ion exchange material escapes or the crystal structure thereof varies to cause deterioration of ion exchange capability.

According to the invention, in such a fuel cell system that a liquid fuel is directly supplied to an electrode, such as a direct methanol fuel cell, metallic ions originated from the inside and outside of the system are suppressed from being formed and are effectively collected, whereby the cell capability can be suppressed from being deteriorated.

The invention will be described in more detail with reference to the following example.

### EXAMPLE

### Examples 1 to 6, and Comparative Example 1

Into a beaker were placed 10 g of pulverized zirconium phosphate and about 50 ml of Nafion solution (20% non-volatile content dispersed in a solvent consisting of ethanol and propanol) which is provided with cation exchange capability. After the mixture was mixed for 1 hr by means of a stirrer, the piping used in an cell unit was immersed in the slurry whereby the ion exchange material was coated on the inner surface of the piping. (Example 1) After coating, the coated layer was dried at a temperature between room temperature and 100° C. The coating and drying operations were repeated until the coated layer has the pre-determined thickness (about 30 μm). Since the high polymer material (silicone, PEEK or PFA) usually used for piping is incorporated with various additives such as catalysts in the synthetic step, inorganic metal ions included in the additives dissolve out when the material is exposed to an organic solvent such as methanol used for fuel cells. And, these ions accumulate in the cell part in the power unit, making it difficult to maintain the cell performance.

In the piping member in accordance with the present invention, coating an ion exchange member on the inner wall of the piping prevents contamination of metallic ions into the power unit.

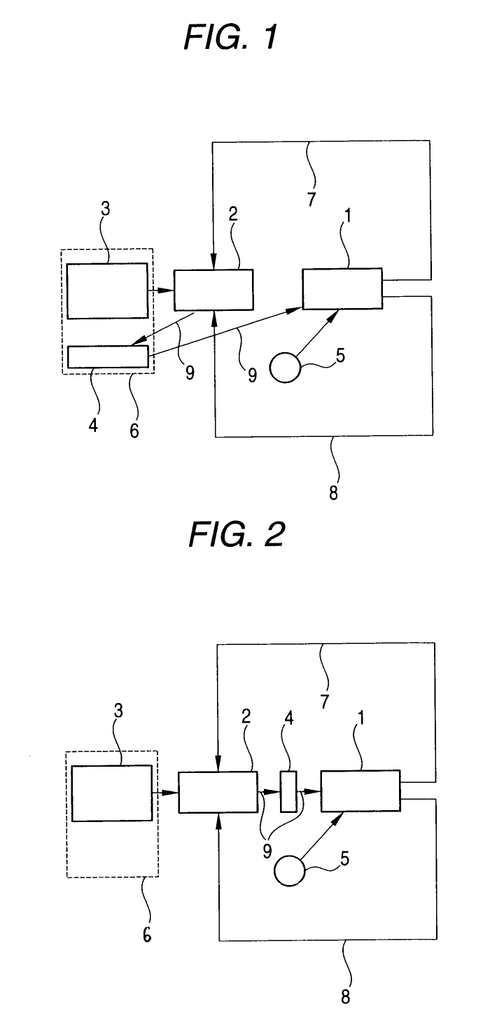

FIG. 1 and FIG. 2 are constitutional views showing examples of a fuel cell system of liquid fuel direct supply type (direct methanol fuel cell system using methanol as a liquid fuel). In these system, a high concentration fuel (pure methanol) is supplied from the outside by using a high concentration fuel cartridge 3 disposed in a cartridge 6, and the methanol concentration inside the unit is adjusted in a fuel tank 2 by diluting with water formed in a cell part 1, whereby the system is operated for a prolonged period of time. Therefore, the piping 9 (fuel supplying line) connected to an anode and a cathode inside the unit is substantially exposed to the liquid (a methanol aqueous solution or water) or a gas containing saturated vapor. The liquid (a methanol aqueous solution) supplied to the anode inside the unit is maintained at a constant concentration with water formed in the cathode and the fuel supplied from the high concentration fuel cartridge 3, and is circulated inside the unit. The fuel tank 2 is connected to the cell part 1 through an anode circulation line 7 and a cathode discharge line 8, and an air pump 5 is provided to supply air to the cell part 1. FIG. 1 shows one embodiment of the fuel cell system in which a filter 4 is disposed in the interior of the cartridge 6. FIG. 2 shows another embodiment of the fuel cell system in which the filter 4 is disposed at the piping 9 connecting between the cell part 1 and the fuel tank 2. The liquid containing a certain concentration of the fuel supplied to the anode in the unit has pH lowered to 3 to 4 and contains metallic ions, specifically Na, K, Ca and the like, eluted from the piping or the like in the absence of the coated layer and the filter. The metallic ions are incorporated into the ion exchange material (mainly the electrolyte film) of the cell component during electric power generation to cause reduction in output power.

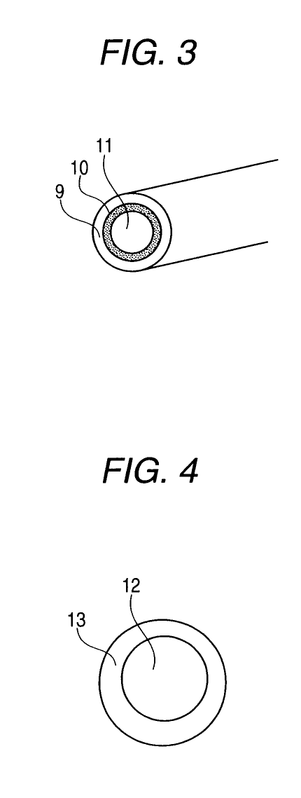

The coated layer of the invention is provided on the cartridge housing the high concentration fuel, the piping and the fuel tank connected to the anode, and the piping connected to the cathode, which are in contact with the liquid in the system, whereby metallic ions are prevented from being eluted from these members. This embodiment is constituted by piping 9, inorganic-organic composite ion exchange coated layer 10, and hollow portion 11 through which the liquid passes, as shown in FIG. 3.

In addition to the combinations of the aforementioned inorganic and organic composite materials, the following compositions: 10 g of pulverized zirconium phosphate, 10 g of tetramethoxysilane, 2 g of water, 3 g of ethanol, and 1 g of formamide (Example 2), 10 g of pulverized zirconium phosphate, 10 g of titanium tetrapropoxide, 2 g of water, 10 g of ethanol, and 1 g of formamide (Example 3), 10 g of pulverized zirconium phosphate, 10 g of zirconium tetrapropoxide, 2 g of water, 10 g of ethanol, and 1 g of formamide (Example 4), 10 g of pulverized zirconium phosphate, 5 g of tetramethoxysilane, 3 g of titanium tetrapropoxide, 2 g of water, 3 g of ethanol, and 1 g of formamide (Example 5), and 10 g of pulverized zirconium phosphate, 5 g of tetramethoxysilane, 3 g of zirconium tetrapropoxide, 2 g of water, 3 g of ethanol, and 1 g of formamide (Example 6), were used to coat the inner surface of a PEEK piping. Each of the resulting pipings and an untreated PEEK piping (with a diameter of 0.5 cm and a length of 20 cm) (Comparative Example 1) were charged with an acid solution of pH 2 and left for 100 hr at 60° C. Then, the solution was analyzed to examine the amount of metallic ions. From the untreated PEEK piping, more than 1 ppm of various ions including Ca, Na, K and the like was detected, but in each coated piping, substantially no dissolution of metallic ions was observed (not exceeding 10 ppb), indicating that the coated layer prevents the dissolution of metallic ions.

Meanwhile, in the description of each Example and Comparative Example, explanations for the portions and conditions common to those of Example 1 were omitted.

The performance comparisons for the foregoing examples and Comparative Example were summarized in Table 1.

As the experimental conditions for each Example and Comparative Example, the PEEK pipings (with a diameter of 0.5 cm and a length of 20 cm) each having a different inner wall coating condition were filled with a mixture of 3% methanol aqueous solution and 0.1% formic acid having a pH of 2, and were subjected to measurement after 100 hr time elapse at 60° C. Table 1 shows the ion concentrations of main metallic ions in the solutions kept in the piping in the individual Examples or Comparative Example.

TABLE 1

| | | | | Total Ion | Thick- | Water |
|---|---|---|---|---|---|---|
| | | | | Concentration | ness | absorption |
| | Na | K | Ca | (ppb) | (um) | (%) |
| Example 1 | 2 | 5 | 1 | 8 | 10 | 38 |
| Example 2 | 1 | 5 | 2 | 8 | 5 | 20 |
| Example 3 | 1 | 1 | 1 | 3 | 10 | 18 |
| Example 4 | 2 | 5 | 3 | 10 | 30 | 15 |
| Example 5 | 1 | 3 | 2 | 6 | 12 | 20 |
| Example 6 | 2 | 4 | 2 | 8 | 18 | 18 |
| Comparative | 1300 | 1000 | 2500 | 4800 | — | — |
| Example 1 | | | | | | |

### Examples 7 to 12

Into a beaker were placed 10 g of pulverized zirconium phosphate and about 25 ml of Nafion solution (20% non-volatile content dispersed in a solvent consisting of ethanol and propanol), which was provided with cation exchange capability. And after mixed for 1 hr by means of a stirrer, the mixture was charged into a mold to fabricate thin pieces with thicknesses of from 10 to 250 μm via drying at a temperature ranging from room temperature to 70° C. (Example 7) Then, about 8 g of particles with particle diameters from 400 to 600 μm (FIG. 4) obtained by braking and fractionating the thin pieces was charged together with the methanol in the fuel cartridge (about 150 ml, 100% methanol) and used as a fuel cartridge. Meanwhile, as shown in FIG. 4, the inorganic-organic composite ion exchange member is constituted of an interior part made of an inorganic ion exchange member 12 and an exterior part made of an organic member 13. The methanol in the fuel cartridge is kept in a polyethylene bag together with the aforementioned powder.

Since a high polymer material such as polyethylene is incorporated with various additives such as a catalyst in the step of synthesis, the inorganic metal ions included in the additives dissolve out when the material is exposed to an organic solvent such as methanol used for fuel cells. And, these ions accumulate in the cell part in the power unit, making it difficult to maintain the cell performance.

In the fuel cartridge in accordance with the present invention, coexistence of a liquid fuel and an ion exchange member in the cartridge prevents the contamination of metallic ions into the power unit.

Further, it is desirable to insert such member in the flowing path through which a liquid fuel circulates in the power unit, since the metallic ion component resulting from dissolution due to the contact of the circulating liquid with the piping can be collected. As a particularly preferable location for arrangement, the position just in front of the cell component (placed at the entrance at the anode side) is mentioned.

In addition to the aforementioned inorganic and organic composite compositions, those comprising: 30 g of pulverized zirconium phosphate, 20 g of tetramethoxysilane, 30 g of water, and 3 g of formamide (Example 8), 10 g of pulverized zirconium phosphate, 30 g of titanium tetrapropoxide, 30 g of water, and 3 g of formamide (Example 9), 30 g of pulverized zirconium phosphate, 20 g of zirconium tetrapropoxide, 30 g of water, and 3 g of formamide (Example 10), 30 g of pulverized zirconium phosphate, 15 g of tetramethoxysilane, 5 g of titanium tetrapropoxide, 30 g of water, 10 g of ethanol and 3 g of formamide (Example 11), and 30 g of pulverized zirconium phosphate, 15 g of tetramethoxysilane, 5 g of zirconium tetrapropoxide, 2 g of water, 10 g of ethanol and 3 g of formamide (Example 12), were used to prepare granular particles similar to the aforementioned ones, which were heat-treated at about 150° C. for 3 hr. To verify the ion exchange capability of these particles, about 10 g of the particles was immersed in 100 ml of methanol which contained 1 ppm of aluminum ion prior to the immersion. And, the change in the aluminum ion concentration was investigated after 10 min immersion. The aluminum ion content in every sample reduced to 10 ppb or lower in 10 min, indicating that the sample has sufficient ion exchange capability.

The measurement results for Examples 7 to 12 were summarized in Table 2 in the same manner as in Table 1.

The measuring conditions were as follows. The granular particles in each of Examples 7 to 12 were added to 100 ml water containing 1 ppm Al ion by 10 g, and the mixture was left for standing still for 10 min. After this 10 min, the water was collected to measure the Al ion concentration by means of an ICP emission analyzing apparatus.

TABLE 2

| | Al Ion | Specific | Water | Ion exchange |
|---|---|---|---|---|
| | Concentration | surface area | absorption | capacity |
| | (ppb) | (m2/g) | (%) | (m-eq/g) |
| Example 7 | 5 | 55 | 25 | 4.2 |
| Example 8 | 1 | 450 | 38 | 2.5 |
| Example 9 | 1 | 300 | 51 | 3.8 |
| Example 10 | 2 | 250 | 48 | 3.6 |
| Example 11 | 0 | 400 | 42 | 4 |
| Example 12 | 0 | 500 | 45 | 4.2 |

From Table 2, it has been verified that every sample is provided with desirable ion exchange capability since the Al ion concentration was always 10 ppb or less.

### Examples 13 to 18

After 30 g of zirconium phosphate, 30 g of water and 20 g of tetramethoxysilane were mixed in a beaker, the resulting mixture was coated on a Teflon board to give a thin film of 100 to 200>m thickness. After drying, this thin film was subjected to heat treatment at 70° C. (Example 13), 100° C. (Example 14), 150° C. (Example 15), 200° C. (Example 16), 250° C. (Example 17), or 300° C. (Example 18) for 3 hr. Then, each film piece was pulverized and fractionated to prepare an ion filter containing 5 g of 10 to 100 μm size particles. To confirm the ion exchange capability of each ion filter, the ion filter thus prepared was immersed for 10 min in 100 ml of 3% methanol aqueous solution which contained 1 ppm of aluminum ion prior to the immersion. And, the change in the aluminum ion concentration in the aqueous solution was investigated. The aluminum ion content in each example decreased. It was proved that the ion filters subjected to heat treatment at 100 to 250° C. have particularly preferable capabilities. The measurement results for Examples 13 to 18 were summarized in Table 3.

TABLE 3

| | | Al Ion | Specific | Ion exchange |
|---|---|---|---|---|
| | Temperature | Concentration | surface area | capacity |
| | (degree C.) | (ppb) | (m2/g) | (m-eq/g) |
| Example 13 | 70 | 10 | 50 | 3 |
| Example 14 | 100 | 5 | 120 | 3.1 |
| Example 15 | 150 | 2 | 430 | 3.2 |
| Example 16 | 200 | 0 | 450 | 3.1 |
| Example 17 | 250 | 1 | 480 | 2.9 |
| Example 18 | 300 | 10 | 500 | 2.4 |

1. A fuel cell system comprising:
a proton-conductive solid polymer film as an electrolyte;
a cell part comprising an anode and a cathode disposed to face each other with the proton-conductive solid polymer film intervening therebetween;
an ion scavenger for removing metal ions from a liquid fuel, the ion scavenger comprising an ion exchange material comprising at least one of zirconium phosphate and antimony oxide; and
a matrix member comprising at least one of silicon oxide, zirconium oxide and titanium oxide, the matrix member dispersing the ion exchange material therein;
a fuel supplying line for supplying the liquid fuel to the cell part while the liquid fuel is kept in contact with the ion scavenger; and
an oxygen supplying line for supplying oxygen to the cell part.

2. The fuel cell system according to claim 1, wherein the fuel supplying line is a piping and the ion scavenger is in the form of a coating that is present on an inner side of the piping.

3. (canceled)

4. The fuel cell system according to claim 1, wherein the ion scavenger has a particle size distribution ranging from 10 to 1000 μm.

5. The fuel cell system according to claim 1, wherein the ion scavenger is an aggregate of particles and has a specific surface area of from 50 to 500 m²/g.

6. The fuel cell system according to claim 1, wherein the ion scavenger comprises:
an ion exchange material comprising one of zirconium phosphate and antimony oxide; and
a matrix member comprising a water absorbing organic material.

7. The fuel cell system according to claim 1, wherein the ion scavenger has an exchange capacity of from 2 to 6 m-eq/g.

8. The fuel cell system according to claim 1, wherein the ion scavenger has an exchange capacity of from 4 to 6 m-eq/g.

9. The fuel cell system according to claim 1, wherein the ion scavenger is disposed in a vicinity of the cell part.

10. A fuel cell system comprising:
a proton-conductive solid polymer film as an electrolyte;
a cell part comprising an anode and a cathode disposed to face each other with the proton-conductive solid polymer film intervening therebetween;
a fuel cartridge;
an ion scavenger for removing metallic ions from a liquid fuel, an ion exchange material comprising at least one of zirconium phosphate and antimony oxide; and
a matrix member comprising at least one of silicon oxide, zirconium oxide and titanium oxide, the matrix member dispersing the ion exchange material therein and disposed in the fuel cartridge;
a fuel supplying line for supplying the liquid fuel to the cell part while the liquid fuel is kept in contact with the ion scavenger;
an oxygen supplying line for supplying oxygen to the cell part.

11. The fuel cell system according to claim 10, wherein the fuel supplying line is a piping and the ion scavenger is in the form of a coating that is present on an inner side of the piping.

12. (canceled)

13. The fuel cell system according to claim 10, wherein the ion scavenger has a particle size distribution ranging from 10 to 1000 μm.

14. The fuel cell system according to claim 10, wherein the ion scavenger is an aggregate of particles and has a specific surface area of from 50 to 500 m²/g.

15. The fuel cell system according to claim 10, wherein the ion scavenger comprises:
an ion exchange material comprising one of zirconium phosphate and antimony oxide; and
a matrix member comprising a water absorbing organic material.

16. The fuel cell system according to claim 10,
wherein the ion scavenger has an exchange capacity of from 2 to 6 m-eq/g.

17. (canceled)

18. An ion scavenger, for removing metallic ions from a liquid fuel, wherein the ion scavenger comprises:
an ion exchange material comprising at least one of zirconium phosphate and antimony oxide; and
a matrix member comprising at least one of silicon oxide, zirconium oxide and titanium oxide, the matrix member dispersing the ion exchange material therein.

19. The ion scavenger according to claim 18, wherein the ion scavenger has a particle size distribution ranging from 10 to 1000 μm.

20. The ion scavenger according to claim 18, wherein the ion scavenger is an aggregate of particles and has a specific surface area of from 50 to 500 m²/g.

21. The fuel cell system according to claim 1, wherein said ion exchange material comprises one of zirconium phosphate and antimony oxide; and
said matrix member comprises one of silicon oxide, zirconium oxide and titanium oxide.

22. The fuel cell system according to claim 10, wherein said ion exchange material comprises one of zirconium phosphate and antimony oxide; and
said matrix member comprises one of silicon oxide, zirconium oxide and titanium oxide.

23. The ion scavenger according to claim 18, wherein said ion exchange material comprises one of zirconium phosphate and antimony oxide; and
a matrix member comprises one of silicon oxide, zirconium oxide and titanium oxide.
